(19) United States
(12) Patent Application Publication
(10) Pub. No.: US 2022/0332017 A1
(43) Pub. Date: Oct. 20, 2022

(54) UNDERWATER GRANULATION SYSTEM, AND METHOD FOR GRANULATING A POLYMER MELT

(71) Applicant: BASF SE, Ludwigshafen am Rhein (DE)

(72) Inventors: Michael Freese, Lemfoerde (DE); Torben Kaminsky, Lemfoerde (DE)

(73) Assignee: BASF SE, Ludwigshafen am Rhein (DE)

(21) Appl. No.: 17/753,082

(22) PCT Filed: Aug. 20, 2020
(86) PCT No.: PCT/EP2020/073339

§ 371 Date: Feb. 17, 2022

(30) Foreign Application Priority Data
Aug. 20, 2019 (EP) 19192481.0

(51) Int. Cl. B29B 9/06

(52) U.S. Cl. CPC B29B 9/065

(57) ABSTRACT

An underwater granulation system has a water box, a perforated plate with multiple through-openings for feeding a polymer melt into the water box, and a cutting plate support which is arranged in the water box so as to be driven in rotation about an axis of rotation (X) in a cutting direction. The cutting plate support has multiple cutting plates which face the perforated plate and are adapted to form granules by shearing particles from the polymer melt entering through the perforated plate. The water box is connected to a water supply for heat evacuation and for evacuating the separated particles from the water box. The water box also has a hollow cylindrical portion relative to the axis of rotation (X), in which multiple water inlets distributed over the circumference and multiple water outlets distributed over the circumference are arranged.

The present invention relates to an underwater granulation system, in particular an underwater microgranulation system, having a water box, a perforated plate with multiple through-openings for feeding polymer melt into the water box, a cutting plate support which is arranged in the water box so as to be driven in rotation about an axis of rotation in a cutting direction, wherein the cutting plate support has multiple cutting plates which face the perforated plate and are adapted to separate particles from the polymer melt entering through the perforated plate, and the water box is connected to a water supply for heat evacuation and for evacuating the separated particles from the water box.

Granulation systems of the type indicated above are generally known. They are used to process plastics, in particular polymers such as, for example, thermoplastic polyurethanes or intermediates for the production of such substances, to corresponding granules. The granules are in turn used for industrial processes. The granules are often melted again in further processing, unless they are used directly for specific purposes.

For the further processability, and depending on the field of use for direct use of the granules, it is usually ensured during production, that is to say granulation, that granules with a predetermined particle size and with as homogeneous a shape as possible can be produced. For certain applications, it is desirable, for example, to use particles that are as evenly shaped as possible and approximately spherical. In other applications, it is desirable to be able to produce granules that are as fine as possible (so-called microgranules). The more homogeneous the shape of the granules, the better their pourability in further processing.

For feeding the polymer melt into the water box, the system conventionally has a polymer melt connection for feeding flowing polymer melt, wherein the perforated plate is installed between the water box and the polymer melt connection such that the polymer melt fed in flows through the perforated plate into the water box.

After the particles have been separated from the polymer melt by the cutting plates, they are captured in the water box by the water fed in, cooled and transported out of the water box.

Once the polymer to be granulated has been brought into a molten state, it has been observed that, depending on the material, the melt in some cases has high tackiness. This tackiness can have the result that the separated particles in the water box of the underwater granulation system, before they have cooled sufficiently and solidified, remain adhered to one another or adhere to parts of the system. This adversely affects the shape and size of the particles that are produced and potentially causes increased contamination of the system, which gives rise to shorter maintenance cycles and thus higher costs in operation of the underwater granulation system. In the most extreme case, it is not possible to operate the system at all, since the particles agglomerate too greatly.

Accordingly, it was an object of the invention to overcome the above-described disadvantages as largely as possible. In particular, it was an object of the invention to improve an underwater granulation system of the type described above in a manner that improves the homogeneity of the granule particles that are produced. In particular, it was an object of the invention to improve the above-described underwater granulation system in a manner that reduces the adhesion of the particles to one another and the deformation thereof after separation.

The invention achieves the object in an underwater granulation system of the type indicated above in a first aspect in that the water box has a hollow cylindrical portion relative to the axis of rotation, in which multiple water inlets distributed over the circumference and multiple water outlets distributed over the circumference are arranged.

According to the first aspect, the invention makes use of the finding that, by dividing the water feed between multiple water outlets over the circumference of the water box, and by removing the water from the water box via multiple water outlets distributed over the circumference, significantly improved water circulation in the water box is achieved. The residence time of the separated particles in the water box is thereby reduced significantly, and the particles are thus exposed for a significantly shorter period of time to the risk of adhering to one another or being deformed as a result of collision, so that the homogeneity of the particles is also improved.

In a preferred further development, the water inlets are arranged in a common plane, which is arranged perpendicularly to the axis of rotation, and are distributed preferably evenly over the circumference of the water box. Alternatively or in addition, the water outlets are preferably arranged in a common plane, which is perpendicular to the axis of rotation, and are distributed preferably evenly over the circumference of the water box.

In a further preferred embodiment, the plane of the water inlets and the plane of the water outlets are arranged parallel to one another and are spaced apart from one another.

In a further preferred embodiment, the water inlets and/or the water outlets open into the water box, or out of the water box, eccentrically, preferably in each case by the same amount, and further preferably are oriented tangentially or tangentially parallel. The eccentric, and preferably evenly eccentric, arrangement of the water inlets promotes the generation of a vortex within the water box, which allows the separated particles to be transported more rapidly from the perforated plate out of the cutting chamber. As a result of the eccentric arrangement of the water outlets, this vortex that is generated is taken up in an improved manner and the conveying of the particles out of the water box is improved.

In a further preferred embodiment, the water inlets are oriented eccentrically relative to the axis of rotation such that they generate a whirlpool in the cutting direction, Even if turbulence tends to occur between the water inlets and the cutting plates as a result of the relative speed between the water and the cutting plate support, that is to say in the cutting direction, the negative effects to be expected as a result of the turbulence due to the identical direction of rotation of the water and the cutting plate support are nevertheless kept within limits. As a result, fewer particle collisions occur in the water box.

In a further preferred embodiment, the water inlets are inclined in the direction of the plane of the water outlets, preferably such that in each case a water inlet is oriented substantially in alignment with a water outlet, wherein further preferably the water inlets and outlets so associated with one another are rotated relative to one another by approximately a quarter turn about the axis of rotation. Accordingly, by aligning the water inlets and water outlets with one another, a whirlpool is formed in a targeted manner such that the water can be taken up by the water outlets in a flow-enhancing manner. In a further preferred embodiment, the water outlets are, or the plane of the water outlets is, arranged closer to the cutting plate support than the water inlets, or the plane of the water inlets. As a result, the turbulent flow is formed substantially “at the rear” of the cutting plate support, so that the separated particles are exposed to only moderate shear forces and, after separation, can nevertheless be drawn from the cutting space directly into the water outlets without first having to flow past the water inlets. This also contributes towards reducing the residence time of the particles in the water box.

In a further preferred embodiment, the water box has a first flanged sleeve, on which the water inlets are provided, and a second flanged sleeve, on which the water outlets are provided, wherein the two flanged sleeves are preferably connected to one another in a fluid-tight and reversibly releasable manner. As a result of this modular construction of the water box, rapid replacement and rapid modification of the inlet and outlet geometries is possible, in order to be able to produce, according to the specific application, an ideal fluid flow behavior in the water box, adapted to the particular perforated plate used and to the particular cutting plate support used. This modular construction is also to be preferred for maintenance purposes.

The invention has been described hereinbefore with reference to a first aspect. In a second aspect, the invention achieves the above-described object of improving the underwater granulation system of the type indicated above in that the cutting plate support has a hub portion and multiple carrier arms, which have a first end at the hub portion and extend outwards from the hub portion in an arcuately curved manner to a first end, wherein the cutting plates are fastened to the second end of the carrier arms. The arcuate curve is to be understood in this context as meaning that both a fully arcuate profile of the carrier arm and a profile that is arcuate in only some portions is included. The carrier arm is consequently curved at least in some portions but can also have uncurved, straight portions.

The invention described herein according to the second aspect and the preferred embodiments thereof are at the same time preferred embodiments of the first aspect and an independent aspect of the invention.

In the independent aspect of the invention, the invention accordingly proposes: an underwater granulation system having a water box, a perforated plate with multiple through-openings for feeding polymer melt into the water box, a cutting plate support which is arranged in the water box so as to be driven in rotation about an axis of rotation in a cutting direction, wherein the cutting plate support has multiple cutting plates which face the perforated plate and are adapted to form granules by shearing particles from the polymer melt entering through the perforated plate, and the water box is connected to a water supply for heat evacuation and for evacuating the separated particles from the water box, wherein the cutting plate support has a hub portion and multiple carrier arms which have a first end at the hub portion and extend outwards from the hub portion in an arcuately curved manner to a first end, wherein the cutting plates are fastened to the second end of the carrier arms.

The advantages and preferred embodiments according to the first aspect are at the same so time preferred embodiments and advantages of the second aspect, and for this reason, in order to avoid repetition, reference is made to the above comments.

The invention makes use in the second aspect of the finding that the cutting plate support with its carrier arms, which extend outwards in an arcuate manner from the hub portion, generates significantly less turbulence than prior-known cutting plate supports, which conventionally consisted of solid disks or disk-like cutting bodies. Because the cutting plates are formed on separate carrier arms, water entering the water box is able to flow between the carrier arms to the perforated plate. As a result, evacuation of the separated particles is improved. The better the particles can be evacuated from the perforated plate after separation, the smaller the risk that they will adhere to one another or to parts of the system, as a result of which the homogeneity of the particles is in turn improved, so that the two aspects of the invention achieve the above-described object both separately from one another and in conjunction with one another.

The invention is advantageously developed further in that the hub portion has an outside diameter, and the length of the carrier arms in the radial direction, relative to the axis of rotation, is in each case larger than the diameter of the hub portion. Preferably, the outside diameter is determined at a point which is arranged adjacent to the carrier arms, or between two adjacent carrier arms. The largest outside diameter of the hub portion is applicable in each case.

In a preferred embodiment, the carrier arms project axially, relative to the axis of rotation, from the hub portion in the direction of the perforated plate, so that the second end of the carrier arms having the cutting plates is arranged closer to the perforated plate than the first end. Further preferably, the carrier arms are arranged at the ends at the hub portion. By means of these two measures, and preferably by the combination thereof, a free volume is defined between the cutting plate support and the perforated plate, or the cutting plates, in which a better flow of water is likewise again possible than in prior-known systems. Flow through the region between the cutting plate support and the perforated plate, which is also referred to as the cutting space, is therefore better, as a result of which evacuation of the separated particles is in turn facilitated.

In a further preferred embodiment, the carrier arms are arcuately curved in the axial direction, relative to the axis of rotation, at least at intervals. The arcuate curve of the carrier arm ensures comparatively little disruption of the flow of water inside the water box, because sharp bends can largely be avoided by the arcuate form.

Alternatively or in addition to a curve in the axial direction, the carrier arms are in preferred embodiments curved contrary to the cutting direction at least in some portions, such that the cutting plates are behind the carrier arms on rotation of the cutting plate support in the cutting direction. This is to be understood as meaning that the carrier arms, when seen in a plane perpendicular to the axis of rotation, because they are curved at least in some portions, first extend radially starting from the first end, but then deviate further from the radial line contrary to the cutting direction the closer one comes to the second end of the carrier arms.

Particularly preferably, the carrier arms are curved contrary to the cutting direction as described hereinbefore both in the axial direction and in the circumferential direction. Particularly preferably, constant, smooth transitions between curved and uncurved portions are chosen, or a continuous curve throughout, in order again to reduce turbulence as far as possible.

In a further preferred embodiment, the carrier arms each have an arm thickness which decreases from the first end in the direction of the second end at least in some portions, preferably continuously. This again also increases the free space in the water box that is not occupied by the cutting plate support.

In a further preferred embodiment, in which the cutting plates are each reversibly releasably attached to the carrier arms by means of a fastening screw, the fastening screw is arranged so that it is fully recessed in the mounted state. To this end, a corresponding recess is preferably introduced into the cutting plates and into the carrier arms, in which on the one hand the cutting plates and on the other hand the fastening screws are arranged in a recessed manner. It has been shown that a large part of the undesirable deformations of the particles observed in the prior art was produced by the particles colliding with protruding artefacts in the water box. These also include the fastening screws, which in prior-known systems usually protruded with their screw heads from the cutting plates or from the cutting plates. By sinking the screw heads into the material of the carrier arm, or of the cutting plate, the degree of deformation of the particles is reduced to a surprisingly great extent.

In preferred embodiments, it is possible both to screw the cutting plates directly to the carrier arm and to screw the cutting plates by means of an indirect screw connection via grub screws and clamping levers. By recessing the screw heads, it is strictly speaking immaterial whether screwing is carried out from the side that faces the perforated plate or from one of the other sides. In order to avoid turbulence, however, it is considered to be particularly advantageous to arrange the recess for receiving the fastening screw on the so side that faces the perforated plate.

In a further preferred embodiment, the carrier arms each have at their second end a recess for receiving a cutting plate, wherein the recess is so arranged that the cutting plate, when driven in the direction of rotation, is supported in the recess against the respective carrier arm. Improved force transfer from the cutting plate into the carrier arm is thereby achieved.

Further preferably, the recess has a contour and a depth which are so adapted to the thickness of the received cutting plate that the cutting plate is flush with the surface of the carrier arm. At least the surface transition between the cutting plate and the carrier arm is also configured in a flow-enhancing manner, and the corresponding risk of collision of the separated particles with sharp edges inside the water box is also reduced further.

In a further preferred embodiment, the cutting plates have a cutting edge and, starting from the cutting edge, a first face facing the perforated plate and a second face facing away from the perforated plate, wherein the cutting edges are arranged so as to project in the direction of rotation, and wherein the second face is inclined relative to the axis of rotation, preferably in an angle range from 5-25°, particularly preferably in a range from 12-18°. In other words, the first and second faces preferably span an acute angle with one another. Further preferably, the first face is oriented parallel to the plane of the perforated plate. As a result of the angle, the second face, in conjunction with the acute angle and the cutting edge projecting in the direction of rotation, constitutes a bevel towards the rear—that is to say contrary to the direction of rotation—and the separated particles are evacuated along the second face advantageously directly to the rear and can quickly be removed from the cutting space.

In preferred alternative embodiments, the cutting plate support has 4, 6, 8 or more carrier arms. The number of carrier arms is preferably chosen in dependence on the available space in the water box and the required production capacity of the underwater granulation system.

The invention has been described hereinbefore on the basis of a first and second aspect in relation to the underwater granulation system. In a third aspect, the invention relates further to a method for granulating a polymer melt under water, comprising the steps:
feeding a polymer melt to a water box by conveying the polymer melt through through-openings provided in a perforated plate,
rotating a cutting plate support about an axis of rotation in a cutting direction in the water so box, so that particles are separated from the polymer melt and granules are formed, and
generating a flow of water in the water box such that thermal energy and separated particles are evacuated out of the water box, wherein a granulation system according to one of the above-described embodiments of the first and/or second aspect is used.

The invention accordingly likewise relates also to the use of the above-described underwater granulation system for granulating a polymer melt under water.

The advantages and preferred embodiments of the underwater granulation system according to the first and second aspects are at the same time preferred embodiments and advantages of the method according to the third aspect and vice versa, and for this reason, in order to avoid repetition, reference is made to the above comments.

The invention is described in more detail below on the basis of a preferred example with reference to the attached figures. The figures show:

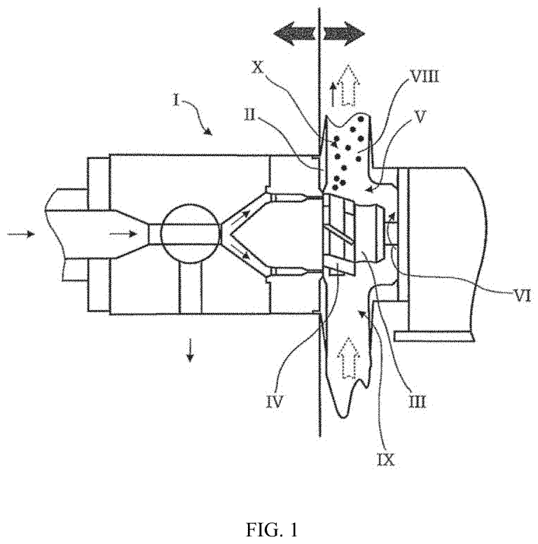

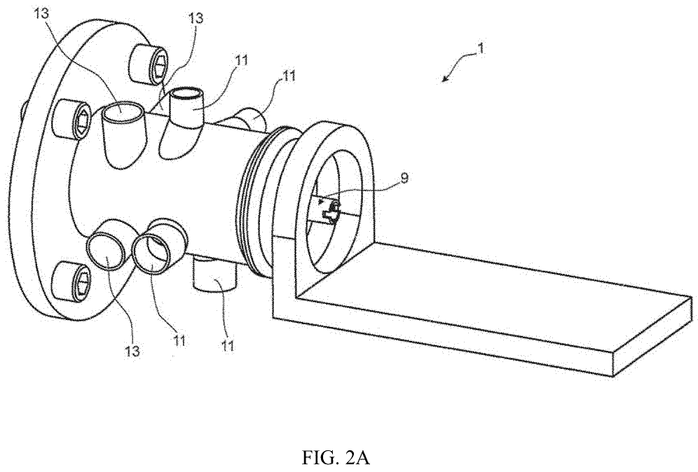

FIG. 1A diagrammatic view of an underwater granulation system according to the prior art,

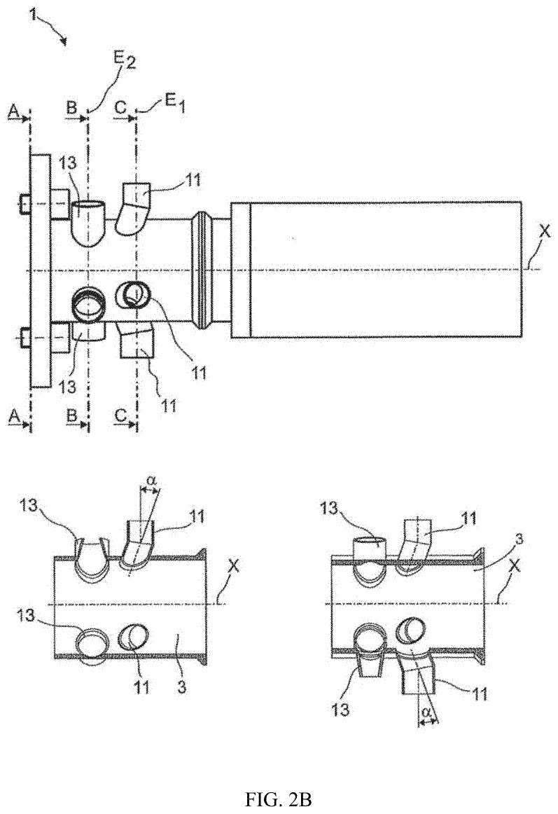

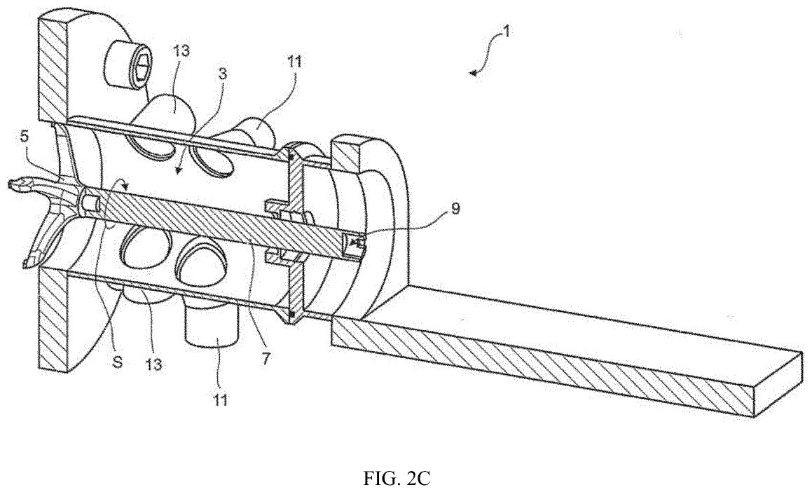

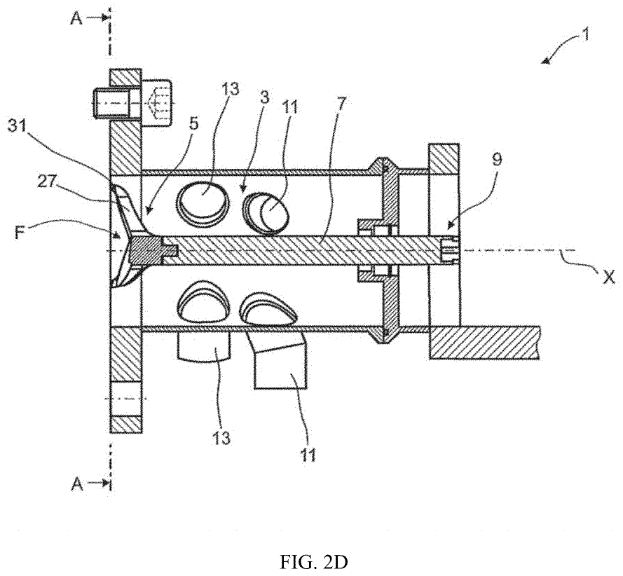

FIG. 2a-d Various diagrammatic views of a granulation system according to the preferred example,

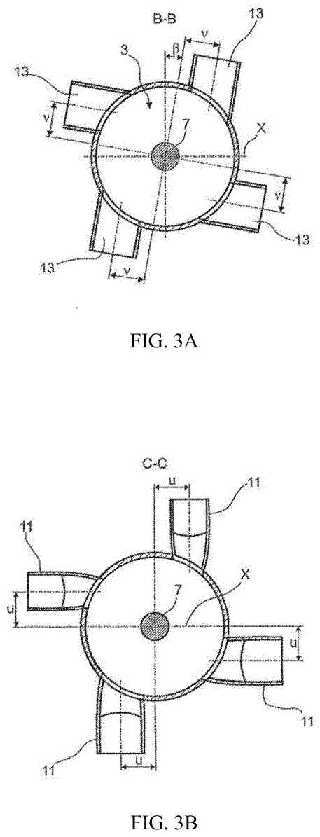

FIG. 3a, h Diagrammatic sectional views relating to FIG. 2b,

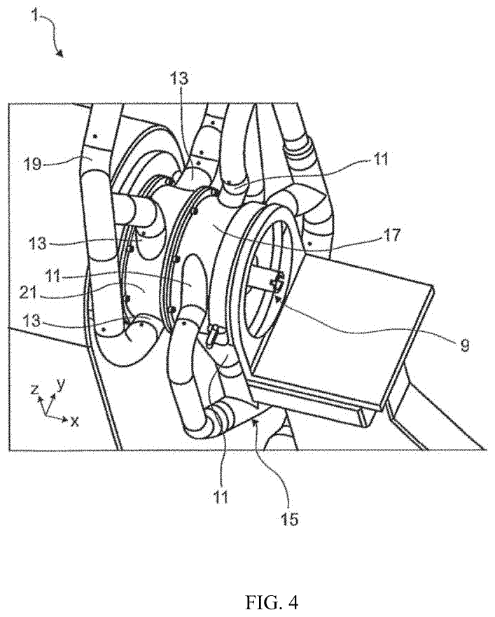

FIG. 4 A diagrammatic spatial view of a detail of the granulation system according to FIG. 2a-d,

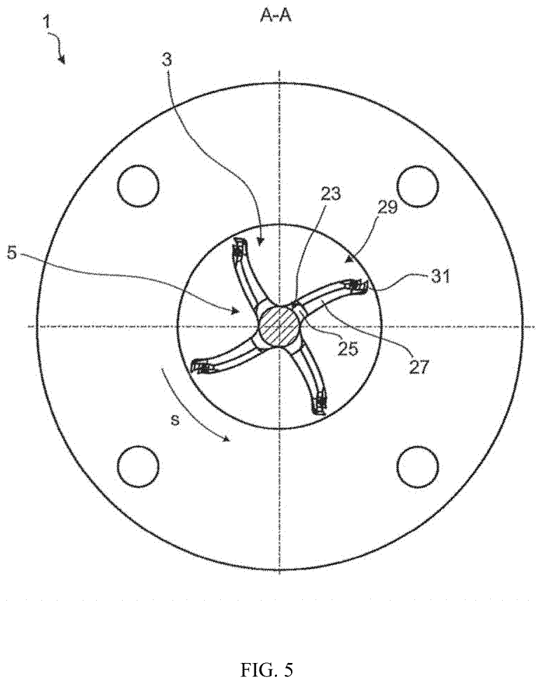

FIG. 5A detail view of a cutting plate support in the arrangement according to FIG. 2b,

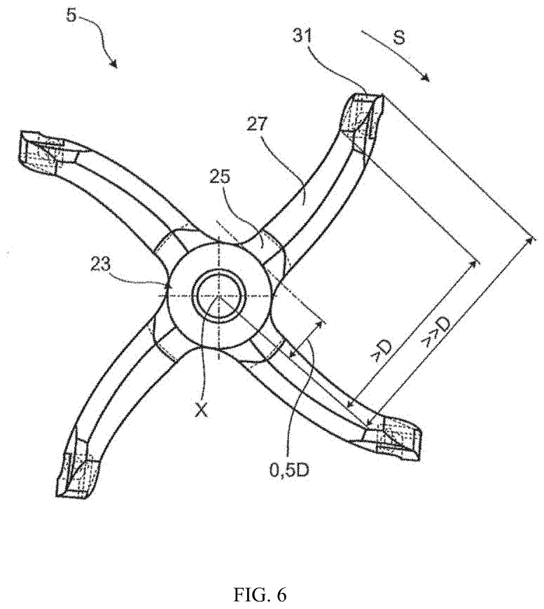

FIG. 6 A diagrammatic plan view of the cutting plate support according to FIG. 5 in a different orientation, and

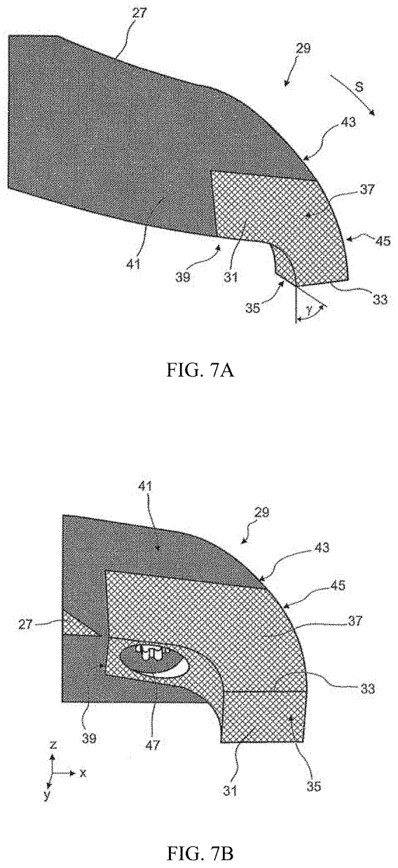

FIG. 7a, h Diagrammatic detail views of the cutting plate support according to FIGS. 5 and 6 and of the underwater granulation system according to FIG. 2a-d.

In order to explain the basic structure also of the granulation system according to the invention, a conventional underwater granulation system is first shown. FIG. 1 shows an underwater granulation system according to the prior art. This underwater granulation system has a first region I, in which a polymer melt is heated to a predetermined temperature and fed by means of multiple delivery channels to a perforated plate IL The perforated plate II has a plurality of through-openings, through which the polymer melt enters a water box V. In the water box V there is arranged a cutting plate support III, which is driven in rotation about its axis of rotation in a cutting direction VI. By the rotation in the cutting direction VI, a plurality of cutting plates IV are moved along the perforated plate II, whereby particles VIII are separated from the polymer melt. The particles VIII cool in the water box V owing to the water conducted therein. The water in the water box V is fed in through a water inlet IX, flows through the water box in a vertically ascending manner and is discharged through a water outlet IX. The particles VIII are carried along by the flow of water and leave the water box V.

The basic construction of the underwater granulation system according to the invention is based, apart from the perforated plate, substantially on the example of the prior art, and for this reason, in order to avoid repetition, reference is made to the above explanations relating to FIG. 1. The underwater granulation system 1 according to the invention according to the further figures has, adjacent to the perforated plate (not shown), a water box 3, which is preferably in the form of a hollow cylindrical chamber. In the water box 3 there is arranged a cutting plate support 5, which is driven in rotation about an axis of rotation X in a cutting direction S by a drive shaft 7. The drive shaft 7 is guided out of the water box 3 and has at its end remote from the cutting plate support 5 a coupling interface 9, which is configured for attachment to a motor drive.

The water box has multiple water inlets 11, which are arranged on the water box 3 distributed over the circumference. The water box 3 further has multiple outlets 13, which are likewise arranged distributed, preferably evenly, over the circumference.

As is apparent from FIG. 2a-d and 3a, b, the water inlets 11 are together arranged in a first plane E1, section plane C-C, while the water outlets 13 are together arranged in a plane E2, section B-B, which is spaced apart from the first plane E1 and parallel thereto. The plane E2 of the water outlets is arranged closer to the plane of the perforated plate, section A-A, than the plane E1 of the water inlets 11.

As will further be understood with reference to FIGS. 2a, c and 3a, b, the water inlets 11 are arranged eccentrically, relative to a radial line starting from the axis of rotation X, in each case by the same amount u. As a result of this eccentric arrangement, the water inlets 11 are in principle in the form of tangential inlets, or are oriented tangentially parallel. They are positioned such that a whirlpool is generated within the water box 3. As can further be seen in particular in FIG. 2b, the water inlets 11 are not only arranged eccentrically but are further arranged inclined in the direction of the second plane E2, in which the water outlets 13 are located, namely by an angle α. As a result of this inclination, they are aligned substantially with the water outlet 13 that is rotated through a quarter turn (about the axis of rotation X).

The water outlets 13 in the plane E2 are oriented substantially perpendicularly to the axis of rotation X and, like the water inlets 11, are also offset by in each case an equal amount v from a radial through the axis of rotation X. Accordingly, they are also oriented tangentially parallel and attached eccentrically to the water box 3. This results in improved discharge from the water box 3 with the separated particles. Relative to the water inlets 11 in the plane E1 the water outlets 13 in the plane E2 are arranged offset about the axis of rotation X by a predetermined angle β.

Hitherto, the arrangement of the water inlets and outlets 11, 13 of the underwater granulation system 1 has substantially been described. FIG. 4 shows in principle a possible method of attaching the water inlets and outlets 11, 13 and a possible detailed construction of the water box 3.

Accordingly, it is shown in FIG. 4 that the water inlets 11 are attached via external piping, which constitutes a water inlet manifold 13 and is connected in a fluid-conducting manner to a cooling water source.

The water inlets 11 are arranged in the form of inlet ports on a first flanged sleeve 17.

The water outlets 13 are brought together via a water outlet manifold 19. Depending on the type of system, it is provided to circulate the cooling medium and, after filtering out the particles, to guide the outlet side to the cooling water source again.

The outlets 13 are arranged in the form of outlet ports on a second flanged sleeve 21. The first and second flanged sleeves 17, 21 are preferably connected directly to one another in a fluid-tight and reversibly releasable manner, in order to provide a modular water box 3.

FIGS. 5-7b are concerned primarily with the geometry of the cutting plate support 5 and of the cutting plates 31. The cutting plate support 5 is depicted in the installed state as a plan view in plane A-A (see FIG. 2b), in effect from the perforated plate. The cutting plate turner 5 has a hub portion 23 on which a plurality of carrier arms 27 are formed with a first end 25. The carrier arms extend outwards in an arcuate manner from the first end 25 to a second end 29, to each of which a cutting plate 31 is fastened. In the preferred example, a cutting plate support 5 having a total of four carrier arms with cutting plates 31 arranged thereon is shown. However, it is likewise possible according to the invention, in each case adapted to the requirements of the production capacity and to the perforated plate, to use cutting plate supports having a different number of carrier arms, for example 6, 8 or more than 8 carrier arms.

FIG. 5 already shows that the carrier arms 27 help to provide the cutting plate support 5 as a whole with a very volume-saving structural form, so that a large part of the cross-section of the water box 3 remains free in the region of the carrier arms 27 and is able to be flowed through by water.

The carrier arms 27 are arcuately curved contrary to the cutting direction S at least in some portions. As a result, the cutting plates 31, when the cutting plate support 5 is driven, are behind at least a part of the carrier arms 27 by a small amount. This enhances on the one hand the shearing behavior of the particles from the polymer melt passing through the perforated plate, and on the other hand the flow conditions in the water box 3.

In addition to the curve contrary to the cutting direction S shown in detail in FIG. 5, the carrier arms 27 are so arranged at their ends on the hub portion 23 of the cutting plate support 5 that they project from the cutting plate support 5 in the direction of the perforated plate, see in particular FIG. 2d. Optionally, the carrier arms 27 are configured so as to be curved at least in some portions also in the direction of the axis of rotation X. By protruding in the axial direction, the carrier arms 27 create a free space F (see FIG. 2d) between the cutting plate support 5 and the perforated plate (plane A-A), which allows the separated particles to be conveyed away in the direction of the water outlets 13 more quickly and with fewer obstructions.

The size ratios of the carrier arms relative to the hub portion of the cutting plate support 5 are explained in more detail with reference to FIG. 6. The hub portion 5 has an outside diameter D in the region of the first end 25 of the carrier arms 27. The carrier arms 27 have a thickness which, even at the thickest point, is still smaller than the diameter D of the hub portion 25. At the same time, the carrier arms 27 have a length in the radial direction, starting from the axis of rotation X, which is significantly larger than the diameter D. If the dimensions of the carrier arms 27 including the cutting plates 31 are taken as reference values, the length of the carrier arms 27 is even greater. Preferably, the length of the carrier arms is in a range of 1.5×diameter D of the hub portion 23, or more.

In FIG. 7a, the integration of the cutting plates 31 into the carrier arms 27 is explained in more detail. The cutting plate 31 has a cutting edge 33 which projects in the direction of rotation S from the cutting plate, or from the second end 29 of the carrier arm 27. This is achieved in that the cutting edge 33 spans an acute angle γ between a first face 35, which faces the perforated plate, and a second face 37, which faces away from the perforated plate. Along the rear of the cutting edge 33, that is to say in effect along the second face 37, the separated particles are able to slide directly to the rear in the direction of the outlets 13.

The cutting plate 31 is set into a recess 39 which is formed at the second end 29 of the carrier arm 27. The recess 39 is so defined in its depth and width that the second face 37 is flush with a corresponding surface 41 adjacent to the recess 39. At the radially outer end of the second end 29 of the carrier arm 27 there is formed a convexly curved surface 43 through which the recess 39 likewise passes in such a manner that the geometry of the cutting plate 31 continues flush at a radially outer surface 45 of the cutting plate 31. Integrating the cutting plate 31 into the carrier arm 27 in this manner again promotes an advantageous flow profile of the water along the cutting plate support 5.

FIG. 7b shows the carrier arm 27 from FIG. 7a in a view from the perforated plate. This gives a clear view in particular of a fastening screw 47, which is sunk into the cutting plate 31 and the carrier arm 27 such that its screw head is fully recessed in the material and does not protrude from the cutting plate 31, or the carrier arm 27. The potential region of collision with separated particles is thereby avoided. Furthermore, since the cutting plate 31 is supported in the recess 39, the attachment of the cutting plate 31 to the carrier arm 27 is also arranged in such a manner that it can withstand high loads and is stable in the long term.

1-17. (canceled)

18: An underwater granulation system, comprising:
a water box,
a perforated plate with multiple through-openings for feeding polymer melt into the water box,
a cutting plate support which is arranged in the water box so as to be driven in rotation about an axis of rotation (X) in a cutting direction,
wherein the cutting plate support has multiple cutting plates which face the perforated plate and are adapted to separate particles from the polymer melt entering through the perforated plate,
wherein the water box is connected to a water supply for heat evacuation and for evacuating separated particles from the water box, and
wherein the water box has a hollow cylindrical portion relative to the axis of rotation (X), in which multiple water inlets distributed over a circumference of the water box and multiple water outlets distributed over the circumference of the water box are arranged.

19: The underwater granulation system as claimed in claim 18, wherein the multiple water inlets are arranged in a common plane (E1) perpendicular to the axis of rotation and are distributed over the circumference of the water box, and/or
wherein the multiple water outlets are arranged in a common plane (E2) perpendicular to the axis of rotation and are distributed over the circumference of the water box.

20: The underwater granulation system as claimed in claim 19, wherein the common plane (E1) of the multiple water inlets and the common plane (E2) of the multiple water outlets are parallel to one another and spaced apart from one another.

21: The underwater granulation system as claimed in claim 18, wherein the multiple water inlets and/or the multiple water outlets open into the water box eccentrically.

22: The underwater granulation system as claimed in claim 19, wherein the multiple water inlets are inclined in a direction of the common plane (E2) of the multiple water outlets.

23: The underwater granulation system as claimed in claim 18, wherein the multiple water outlets are arranged closer to the cutting plate support than the multiple water inlets.

24: The underwater granulation system as claimed in claim 18, wherein the water box has a first flanged sleeve, on which the multiple water inlets are provided, and a second flanged sleeve, on which the multiple water outlets are provided.

25: The underwater granulation system as claimed in claim 18, wherein the multiple cutting plates are adapted to form the particles by means of shearing, and
wherein the cutting plate support has a hub portion and multiple carrier arms which have a first end at the hub portion and extend outwards from the hub portion in an arcuately curved manner to a second end, wherein the multiple cutting plates are fastened to the second end of the multiple carrier arms.

26: The underwater granulation system as claimed in claim 25, wherein the hub portion has an outside diameter, and a length of the multiple carrier arms in a radial direction, relative to the axis of rotation, is in each case larger than the outside diameter of the hub portion.

27: The underwater granulation system as claimed in claim 25, wherein the multiple carrier arms project axially, relative to the axis of rotation, from the hub portion in a direction of the perforated plate, so that the second end of the multiple carrier arms having the multiple cutting plates is arranged closer to the perforated plate than the first end.

28: The underwater granulation system as claimed in claim 25, wherein the multiple carrier arms are curved contrary to the cutting direction at least in some portions, such that the multiple cutting plates are behind the multiple carrier arms on rotation of the cutting plate support in the cutting direction.

29: The underwater granulation system as claimed in claim 25, wherein the multiple carrier arms each have an arm thickness which decreases from the first end in a direction of the second end, at least in some portions.

30: The underwater granulation system as claimed in claim 25, wherein the multiple cutting plates are each reversibly releasably attached to the multiple carrier arms by a fastening screw, wherein the fastening screw is arranged so that it is fully recessed in a mounted state.

31: The underwater granulation system as claimed in claim 25, wherein the multiple carrier arms each have at their second end a recess for receiving a cuffing plate, wherein the recess is arranged so that the cutting plate, when driven in a direction of rotation, is supported in the recess against the respective carrier arm.

32: The underwater granulation system as claimed in claim 18, wherein the multiple cutting plates have a cutting edge and, starting from the cutting edge, a first face facing the perforated plate and a second face facing away from the perforated plate, wherein the cutting edge is arranged so as to project in a direction of rotation, and wherein the second face is inclined relative to the axis of rotation.

33: A method for granulating a polymer melt under water with an underwater granulation system, the method comprising:
feeding a polymer melt to a water box by conveying the polymer melt through through-openings provided in a perforated plate,
rotating a cutting plate support about an axis of rotation (X) in a cutting direction in the water box, so that particles are separated from the polymer melt and granules are formed, and
generating a flow of water in a hollow cylindrical portion of the water box relative to the axis of rotation (X), by multiple water inlets distributed over the circumference of the water box and multiple water outlets distributed over the circumference of the water box, such that thermal energy and separated particles are evacuated from the water box.

34: Granules, produced from the underwater granulation system as claimed in claim 18.

35: The underwater granulation system as claimed in claim 21, wherein the multiple water inlets open into the water box eccentrically in a same amount and/or the multiple water outlets open into the water box eccentrically in a same amount, wherein the multiple water inlets and the multiple water outlets are oriented tangentially or tangentially parallel, and
wherein the multiple water inlets are oriented eccentrically relative to the axis of rotation to generate a whirlpool in the cutting direction.

36: The underwater granulation system as claimed in claim 22, wherein each of the multiple water inlets is oriented substantially in alignment with one of the multiple water outlets, and wherein the multiple water inlets and the multiple water outlets oriented substantially in alignment are rotated relative to one another by approximately a quarter turn about the axis of rotation.

37: The underwater granulation system as claimed in claim 24, wherein the first flanged sleeve and the second flanged sleeve are connected to one another in a fluid-tight and reversibly releasable manner.
